(19) United States
(12) Patent Application Publication
(10) Pub. No.: US 2015/0125800 A1
(43) Pub. Date: May 7, 2015

(54) GRATE CARRIAGE FOR RECEIVING BULK MATERIAL

(71) Applicant: Outotec ( Finland) Oy, Espoo (FI)

(72) Inventors: Andrej Schulakow-Klass, Wiesbaden (DE); Thomas Holzhauer, Frankfurt am Main (DE); Sergej Ekkert, Darmstadt (DE)

(21) Appl. No.: 14/400,819

(22) PCT Filed: Apr. 19, 2013
(86) PCT No.: PCT/EP2013/058137

§ 371 Date: Nov. 13, 2014

(30) Foreign Application Priority Data
May 14, 2012 (DE) 10 2012 009 511.2

(51) Int. Cl. F27B 21/02; F27D 3/12

(52) U.S. Cl. CPC F27B 21/02; F27D 3/12
USPC 432/11; 432/145

(57) ABSTRACT

A grate carriage for receiving bulk material includes a plurality of grate bars arranged, parallel to each other from a first side to a second side of the grate carriage. The grate bars are movably held in lateral receptacles of the grate carriage and a gap is provided between each adjacent pair of the grate bars. A force application device is arranged on each of the first and second sides of the grate carriage and configured to elastically press the grate bars against each other.

### CROSS-REFERENCE TO PRIOR APPLICATIONS

This application is a U.S. National Stage Application under 35 U.S.C. §371 of International Application No. PCT/EP2013/058137, filed on Apr. 19, 2013, and claims benefit to German Patent Application No. DE 10 2012 009 511.2, filed on May 14, 2012. The International Application was published in English on Nov. 21, 2013 as WO 2013/171022 A2 under PCT Article 21(2).

### FIELD

The invention relates to a grate carriage for receiving bulk material, in particular in a traveling grate of a pellet firing or sintering machine, with a plurality of grate bars arranged parallel to each other, wherein the grate bars are movably held in lateral receptacles of the grate carriage and wherein a gap each is provided between the grate bars. The invention also relates to a method for reducing the wear of the grate bars in such grate carriage.

In pelletizing or sintering plants the bulk material to be treated, for example iron ore, is charged onto grate carriages which form an endless grate carriage chain also referred to as traveling grate. The grate carriages are filled with the bulk material and pass through the pellet firing or sintering machine, in which they are thermally treated. Heating up the bulk material usually is effected in that by means of suction boxes provided below the traveling grate hot gas is sucked through the material layer arranged on the grate carriage and through the grate carriage. The grate as such is formed by a plurality of grate bars arranged parallel to each other, which usually are located one beside the other combined in a loose grate bar package. To provide for sucking through the hot air, gaps of a defined size, which each are fixed by spacer cams, are provided between the grate bars.

As described for example in U.S. Pat. No. 6,523,673 B1, the traveling grates usually are guided in a cycle as endless grate carriage chain, wherein the grate carriages are turned over after passing through the treatment stations, in doing so dump the bulk material lying on the same by gravity and subsequently are guided upside down back to the inlet of the pellet firing or sintering machine, where they are turned over again, before new bulk material to be treated is applied and guided through the treatment stations of the machine. The wheels of the grate carriages are guided on corresponding rails. To prevent the grate bars from falling out when the grate carriages are turned over, said grate bars are positively held in corresponding lateral receptacles of the grate carriage. The connection here ensures an expansion space in width direction, so that the loose grate bar package can increase in size due to the thermal expansion. For this purpose, not the complete grate carriage width is filled with the grate bars, but an expansion space is left, so that the grate bars loosely lie one beside the other in width direction. During operation in the pellet firing furnace, a lateral contact force is obtained between the grate bars due to the thermal expansion.

In DE-PS 11 15 400 it is described that when the grate carriage is turned over, the grate bars often are prevented from falling back into their working position by chunks of sintered material or other residues, which lie below the grate bar supporting surfaces. This problem should be prevented in that the grate bar has support noses which enclose the grate bar carrier flanges with great clearance, wherein the lower surface of the upper support nose is formed conical, in order to be able to slightly urge chunks of sintered material, which possibly have dropped into the same, to the side and into the free gas passage cross-section, when the grate bar falls back into its working position.

In a pellet firing or sintering machine, the traveling grates are exposed to extreme thermal and mechanical loads. The patent DE 10 2008 005 449 B3 of the applicant proposes to monitor the operability of the traveling grate, in order to detect an excessive deformation or wear of the grate bars in good time and then replace the same. The wear as such, however, is not prevented thereby.

### SUMMARY

In an embodiment, the present invention provides a grate carriage for receiving bulk material. The grate carriage includes a plurality of grate bars arranged parallel to each other. The grate bars are movably held in lateral receptacles of the grate carriage and a gap is provided between adjacent grate bars. A force application device is arranged on first and second sides of the grate carriage and is configured to elastically press the grate bars against each other.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a perspective view of a grate carriage according to the invention in accordance with a first embodiment,

FIG. 2 shows a top view of the grate carriage according to FIG. 1,

FIG. 3a schematically shows the essential forces acting when carrying out an embodiment of the invention,

FIG. 3b shows a detail of FIG. 3a in an enlarged representation,

FIG. 4 shows an enlarged partial representation of the grate carriage according to the first embodiment,

FIG. 5 shows a section through the grate carriage according to FIG. 4 along line V-V,

FIG. 6 shows a perspective exploded representation of the components of the force application device in the first embodiment,

FIG. 7 shows a section corresponding to FIG. 5 through a second embodiment of the invention, and

FIG. 8 shows a perspective exploded representation of the components of the force application device in the second embodiment.

### DETAILED DESCRIPTION

It has now been found, by the inventors, that the mode of function of the known grate carriages can be substantially impaired by fired pellets or sintered material getting wedged between the grate bars. This leads to increased thermal stresses and wear. Jamming of the fired pellets occurs stochastically and unsymmetrically across the entire grate carriage width. Even if the penetration process is quite difficult to understand, it must be assumed that first smaller pellets or pellet splinters get wedged in the gap provided between the grate bars and lead to an increase in gap size, which provides for the penetration of larger pellets. Observations of the inventors have shown that after an extended operating period, even pellets with a diameter larger than 6 mm penetrate between the grate bars, although the original gaps specified by the spacer cams are distinctly more narrow. The jamming process is promoted by the grate bar wear, which effects a removal of material and thus an external loss of shape. The roughened surface structure offers better conditions of adhesion for the pellets. Once a pellet is jammed between the grate bars, it effects an additional crosswise position of the adjacent grate bars. The local crosswise position propagates across the entire grate carriage width and intensifies the global jamming and clamping process of individual grate bars. The jamming of hardened pellets between the grate bars impedes the thermal expansion and intensifies the thermal stresses, which primarily are responsible for the damage of the grate bars and the grate carriage. The increase in gap size also effects an increased process gas flow through the grate carriage, which enormously increases the local grate bar wear.

An embodiment of the invention avoids the jamming of pellets or material pieces in the gaps formed between the grate bars and thereby inhibits an increase in size of the same.

In an embodiment, a force application device is provided, which elastically presses the grate bars arranged in parallel against each other. Thus, the grate bars no longer loosely lie one beside the other, but are biased against each other by the force application device, so that widening of the gaps formed between the grate bars becomes more difficult. The elasticity of the force application device nevertheless provides for a thermal expansion, so that damaging stresses do not occur between grate bars and grate carriages. Preferably, the force application device acts vertically to the grate side which is arranged towards the adjacent grate bars.

In accordance with an embodiment of the invention, force application devices are provided on both sides of the grate carriage, in order to achieve a uniform action on the grate bars with a maximum application of force.

In accordance with a particularly preferred embodiment of the invention, the force application device includes at least one spring which exerts a compressive force on the grate bars. Spring materials can withstand the temperatures existing in the pelletizing or sintering machines and reliably and continuously apply the desired compressive force on the grate bars. In principle, however, all those mechanisms are usable as force application devices which provide for an elastic application of force, e.g. a pneumatic loading of the grate bars.

To achieve a uniform two-dimensional transmission of force from the spring to the grate bars, a transmission plate is provided in accordance with an embodiment of the invention.

The thermal load on the force application device is reduced in accordance with an embodiment of the invention in that the force application device is mounted on an outside of the grate carriage and, for example, via a plunger acts on the grate bars through the wall of the grate carriage.

In accordance with an embodiment of the invention, the force application device can be provided on a side wall of the grate carriage, which prevents the bulk material arranged on the grate carriage from falling down laterally and is easily accessible for assembly and maintenance work.

In another embodiment of the invention, the force application device is provided on a frame of the grate carriage. Here, a lower ambient temperature exists. In addition, there is more space for mounting the force application devices. On the other hand, a height difference to the grate bars arranged in the grate carriage possibly must be overcome.

In modern traveling grates, the grate bars mostly are combined to loose grate bar packages, which then are held in the lateral receptacles of the grate carriage. In such a case, the force application device according to an embodiment of the present invention presses the grate bars of each grate bar package against each other.

As there must always functionally be provided a gap between the grate bars, in order to provide for sucking through the air, it may also occur that smaller pellets get wedged in the gaps when using the above-described grate carriages according to embodiments of the invention. To avoid a detrimental increase in size of the gaps in this case, it is provided in a method according to an embodiment of the invention for reducing the wear of the grate bars that the grate bar package is stress-relieved during recirculation of the grate carriages, i.e. after passing through the firing furnace. During the recirculation, the application of force by the force application device thus is interrupted and the pressure acting on the grate bar package is eliminated, which, for example, is possible by a positive counter-recirculation in the grate carriage recirculation, so that the pellets jammed between the grate bars or the like can fall out. This can be achieved in that the pressure bolt on the side facing away from the grate bar package contains a means, such as a bulge, for a preferably positive connection. During the recirculation of the grate carriage, the bulge is automatically introduced by the grate carriage movement into this, preferably positive, connection which corresponds to a curve guide. Due to the curve guide spreading to the outside, the clamping elements are stress-relieved in direction of the grate bars, so that no compressive force acts on the same. During recirculation of the grate carriage, the bulge of the pressure bolt thus latches into a guide extending outside the grate carriage, preferably extending parallel to the rails, so that a corresponding connection is obtained. In a curve, a force opposed to the compression spring consequently acts on these pressure bolts and thus also on the grate bars due to the guide of the pressure bolts extending on the external radius of the curve.

According to a preferred embodiment of the invention, the force application device alternately is tensioned and released during the recirculation, in order to apply an impulse onto the grate bars. Due to the introduction of an impulse and the acting gravitational force, the small pellets and/or material pieces can fall out between the grate bars. The grate carriage thus is cleaned, so that when again passing through the pellet firing or sintering machine and when a force again is applied by the force application device, the originally set gap of a defined width is obtained again.

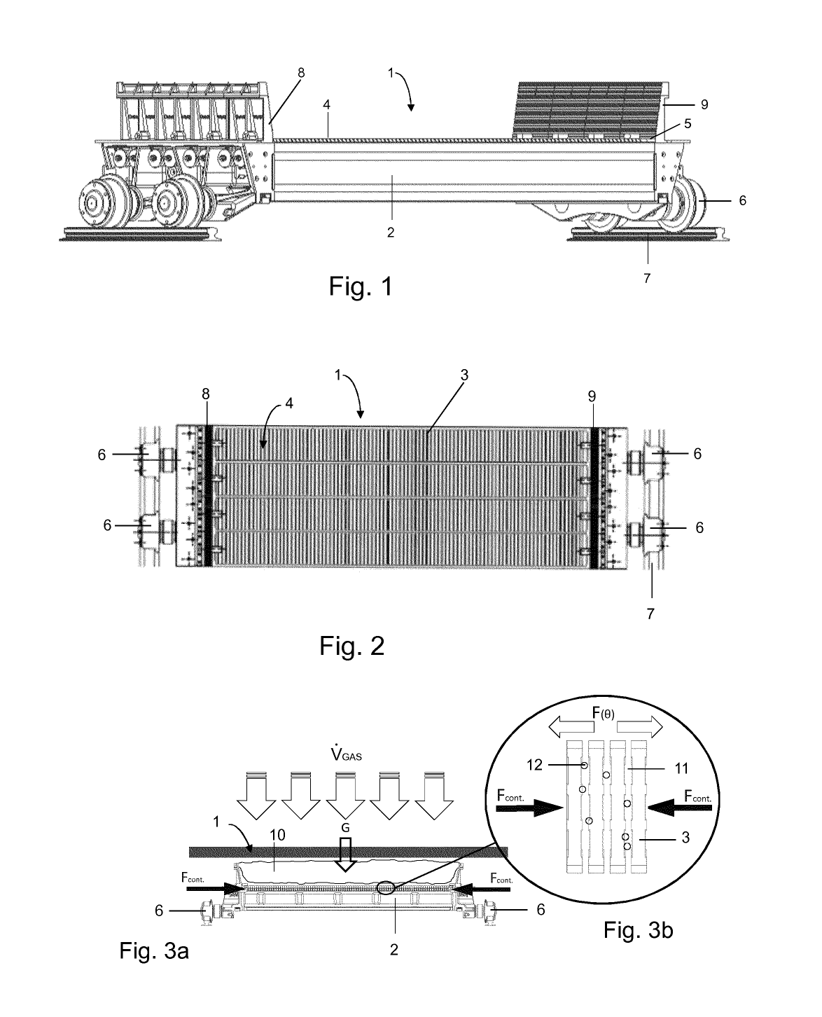

The grate carriage 1 according to a first embodiment of the invention as shown in FIGS. 1 and 2 includes a grate frame 2 on which a plurality of grate bars 3 is arranged. The grate bars 3 arranged parallel to each other each are combined to loose grate bar packages 4 which are movably held in lateral receptacles 5. Via track rollers 6, the grate carriage 1 is guided on rails 7 of a machine for the thermal treatment of bulk material, in particular of a pellet firing or sintering machine. On the grate frame, side walls 8, 9 are arranged for the lateral delimitation of the grate carriage, which hold the bulk material 10 (cf. FIG. 3a), e.g. iron ore or ore pellets, on the grate carriage 1.

As is indicated in FIG. 3a, after applying the bulk material 10 onto the grate carriage 1 and moving the grate carriage e.g. into a pellet firing machine, a gas of high temperature is sucked from above through the material and the gaps 11 provided between the grate bars 3, in order to heat up the bulk material. On the one hand, the weight force G of the bulk material 10 thus acts on the grate carriage 1 and on the other hand the gas is sucked through with the velocity V_{GAS}. Between the grate bars 3 small pellets 12 can get wedged in the gaps 11, as is indicated in FIG. 3b. In the prior art, this is promoted in that the grate bars 3 loosely lie one beside the other and due to the thermal expansion F(θ) a widening of the gaps 11 is effected. According to the present invention, a force F_{cont} applied onto the grate bars 3 from outside continuously acts against such widening, which presses the grate bars 3 against each other. A widening of the gaps 11 thereby is prevented, so that the entry of smaller pellets 12 largely is prevented.

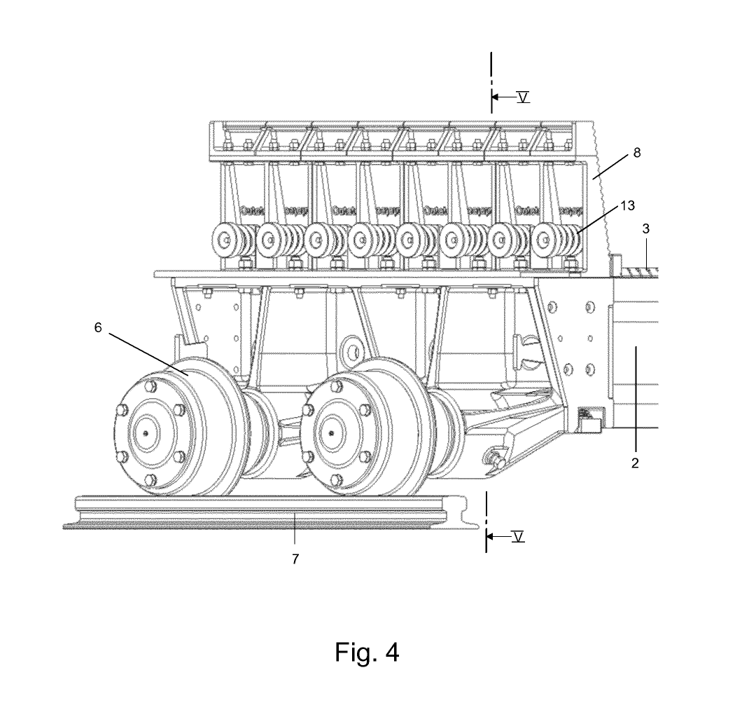

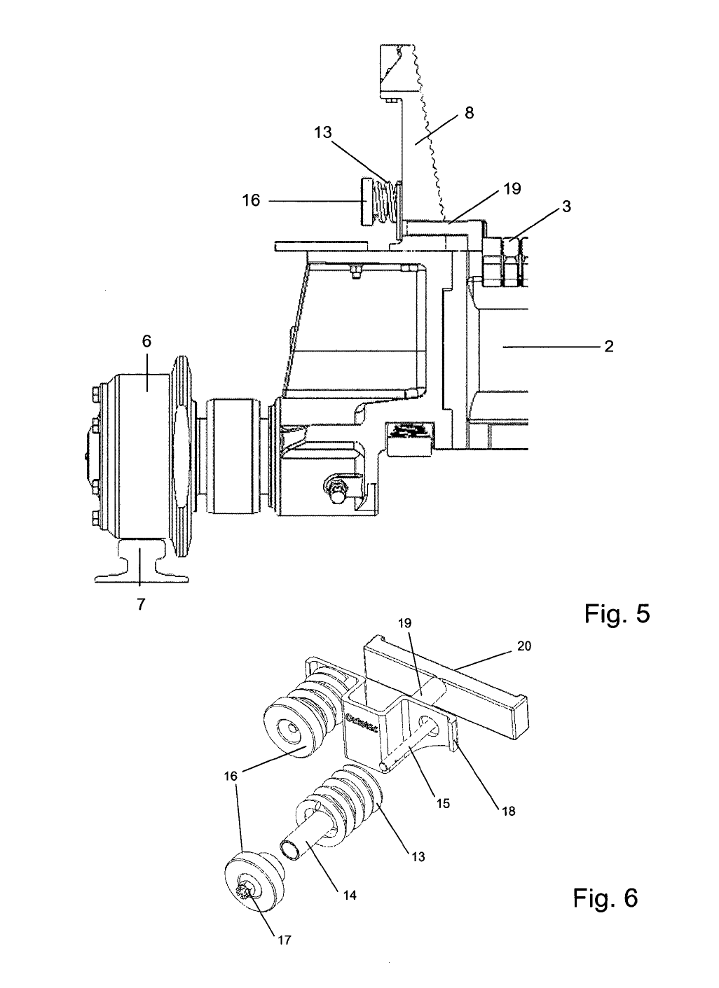

FIGS. 4 and 5 schematically show the arrangement of force application devices according to an embodiment of the invention on the side wall 8 of the grate carriage 1.

As can be taken in particular from FIG. 6, the force application device comprises a compression spring 13 which acts as a constant energy generator and sits on a sleeve 14 which is screwed to the side wall 8 of the grate carriage 1 via a threaded bolt 15. The compression spring 13 is held on the sleeve 14 via a spring holder 16. The spring holder 16 is attached to the threaded bolt 15 via a nut 17. In the illustrated embodiment, two compression springs 13 are provided per grate bar package 4 on each side of the grate carriage 1, which via a transmission clamp or plate 18 act on a plunger 19 which passes through the side wall 8 and transmits the force onto the grate bar package 4 directly or via a transmission element 20. Along the length of the grate carriage 1 numerous force application devices are arranged one beside the other.

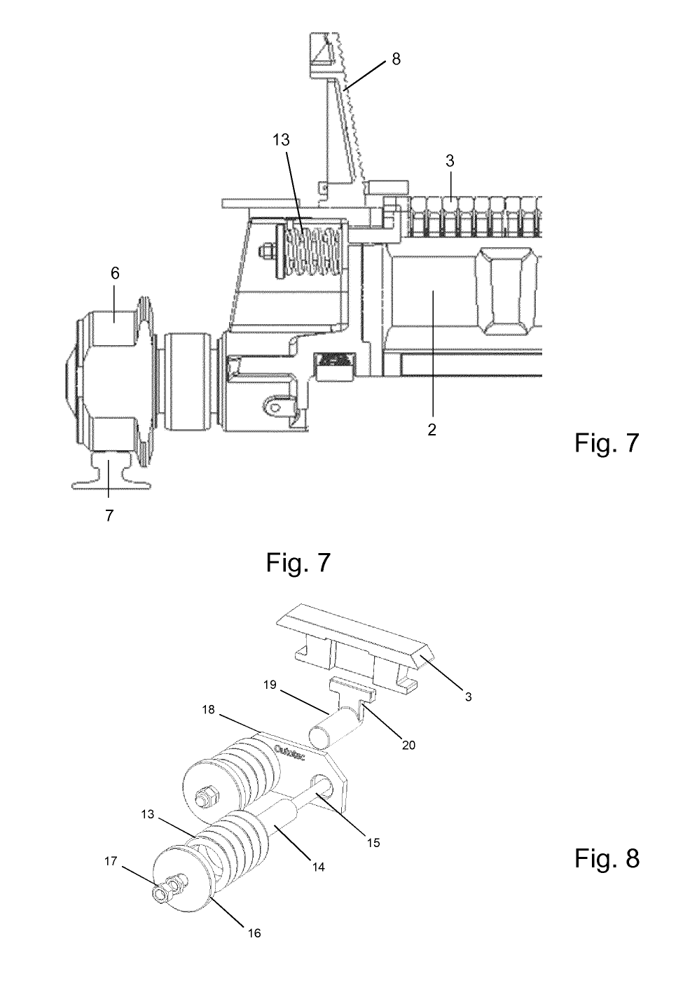

In the second embodiment of the invention as shown in FIGS. 7 and 8, the force application device is mounted on the grate frame 2. As shown in FIG. 8, the force application device here also consists of two compression springs 13 which sit on sleeves 14 and are attached to the grate frame 2 via threaded bolts 15 and a spring holder 16. The spring force is transmitted via a transmission plate 18 to a plunger 19 and from the same to the grate bar 3.

Since the force application devices are provided on both sides of the grate bar package 4, the grate bars are uniformly pressed against each other and the application of force is doubled as compared to a unilateral application.

When the grate carriages 1 in operation are loaded with bulk material 10 and pass through a pellet firing or sintering machine or the like, the grate bars 3 of the grate bar packages 4 are pressed against each other via the force application devices such that the gaps 11 between the grate bars 3 cannot widen. A penetration of pellets and the resulting gap widening thereby is largely avoided. Since the force application devices are elastic, the thermal expansion still is possible, so that no damaging stresses are built up in the grate carriage or grate bar package.

When the grate carriages are turned over after passing through the machine, in order to dump the bulk material, and then are recirculated upside down to the entry of the machine, the pressure applied onto the grate bars via the force application devices is relieved according to a preferred embodiment of the invention, so that smaller pellets, particles or the like, which are jammed in the gaps 11, can fall out. This can be supported in that the force application devices are loaded and unloaded periodically, in order to apply an impulse onto the grate bars and thereby contribute to a loosening of the jammed pellets or the like. By removing pellets or other material pieces jammed between the grate bars according to the invention, a gradual increase in size of the gaps 11 also can be prevented when repeatedly passing through the machine.

With the embodiments of the invention, the wear of the grate bars promoted by the widening of the gaps 11 by wedged pellets or the like thus can be reduced, so that the service life of the grate bars 3 and the grate carriage 1 is increased.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 grate carriage

2 grate frame

3 grate bars

4 grate bar package

5 receptacle

6 track roller

7 rail

8,9 side wall

10 bulk material

11 gap

12 pellet

13 compression spring

14 sleeve

15 threaded bolt

16 spring holder

17 nut

18 transmission plate

19 plunger

20 transmission element

1-10. (canceled)

11. A grate carriage for receiving bulk material, the grate carriage comprising:
a plurality of grate bars arranged parallel to each other, the grate bars being movably held in lateral receptacles of the grate carriage, a gap being provided between adjacent grate bars; and
a force application device arranged on first and second sides of the grate carriage and configured to elastically press the grate bars against each other.

12. The grate carriage according to claim 11, wherein the force application device includes at least one spring which exerts a compressive force on the grate bars.

13. The grate carriage according to claim 12, wherein the at least one spring applies the compressive force onto the grate bars via a transmission plate.

14. The grate carriage according to claim 11, wherein the force application device is mounted on an outside of the grate carriage and acts on the grate bars via a plunger through a wall of the grate carriage.

15. The grate carriage according to claim 11, wherein the force application device is disposed on a side wall of the grate carriage.

16. The grate carriage according to claim 11, wherein the force application device is disposed on a frame of the grate carriage.

17. The grate carriage according to claim 11, wherein the grate bars are combined into a grate bar package which is held in the lateral receptacles of the grate carriage, and wherein the force application device presses the grate bars of the grate bar package against each other.

18. A method for reducing wear of the grate bars of the grate carriage according to claim 11 in a machine for thermal treatment of material present on the grate carriage, the method comprising:
passing the grate carriage through the machine; and then
recirculating, in a cycle, the grate carriage to an entry of the machine,
wherein the force application device is stress-relieved during the recirculation of the grate carriage.

19. The method according to claim 18, wherein the force application device is alternately tensioned and released so as to apply an impulse to the grate bars.
